(19) United States
(12) Patent Application Publication
(10) Pub. No.: US 2008/0067368 A1
(43) Pub. Date: Mar. 20, 2008

(54) Ionizing system for vacuum process and metrology equipment

(75) Inventor: Cheryl Sue Avery, Dublin, CA (US)

Correspondence Address: MKS Instruments Inc., 1750 North Loop Road, Alameda, CA, 94502, US

(73) Assignee: MKS Instruments Inc

(21) Appl. No.: 11/787,569

(22) Filed: Apr. 17, 2007

Related U.S. Application Data
(60) Provisional application No. 60/793,201, filed on Apr. 19, 2006.

(51) Int. Cl. H01J 40/00

(52) U.S. Cl. 250/305

(57) ABSTRACT

Apparatus and method for measuring and controlling static charge inside vacuum equipment. In-line gas ionizers deliver gas ions to pass-through doors, load-locks, vacuum cluster vent lines, or neutralizing chambers. Static charge measurement is accomplished while the wafer or product remains in a vacuum or near-vacuum. In one embodiment, a neutralizing chamber and measurement chamber are combined. This invention has application in semiconductor, disk drive, and flat panel industries.

### CROSS-REFERENCE TO RELATED APPLICATIONS

This application claims priority to U.S. Provisional Application 60/793,201 filed Apr. 19, 2006 entitled “In-situ Ionizers for Vacuum Process and Metrology Equipment”.

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to static charge neutralizers, which are designed to remove or minimize static charge accumulation. Static charge neutralizers remove static charge by generating air ions and delivering those ions to a charged target.

Ionizers are historically utilized inside atmospheric process equipment or metrology equipment. Prior art ionizers are designed for atmospheric environments since air ions are created from air, nitrogen, or other gases that are near the ionizing mechanism (corona electrodes, nuclear sources, X-rays, ultraviolet light, or equivalent).

Process equipment and metrology equipment also operate in vacuum or near vacuum. And static charge neutralization remains necessary. The instant invention is directed toward the need for ionizers in vacuum or low pressure equipment.

Examples of application fields include semiconductor, disk drive, and flat panel display.

2. Description of Related Art

Some process and metrology equipment operate in vacuum or close to vacuum. Examples include scanning electron microscopes, ion implanters, and low pressure chemical vapor deposition chambers.

Getting a wafer, disk, substrates, or panel into the vacuum environment requires a pump down step. Returning the wafer, disk, or panel to atmospheric pressure requires a venting step with a clean gas.

Both pump down and venting are time consuming, and equipment operators would like to minimize the frequency of pump down and venting cycles.

One time-saving approach is to combine multiple vacuum process steps into a vacuum cluster, wherein a central vacuum robot moves product among process or metrology stations. After a single pump down, all vacuum process steps are completed. Then the wafers are returned to atmosphere. Product throughput is increased because only one pumping step and one venting step are needed.

Static charge builds up in vacuum processes as well as in atmospheric processes. And since the wafers remain under vacuum for long periods of time, the wafers are at risk of static charge induced damage.

A need exists to assure that wafers or products (a) enter the low pressure (or vacuum) environment with low static charge, (b) maintain low static charge, and (c) exit with low static charge.

Prior art vacuum equipment attempts to remove static charge (1) before products enter the vacuum environment, and (2) after products leave the vacuum environment. Normally, the static neutralizers are positioned in an atmospheric handler that interfaces to the front of the process equipment. Hence, products pass by the ionizer as they travel in and out of the vacuum chamber.

But the prior art does not offer static charge removal within the vacuum process environment.

In addition, the prior art does not offer a way to measure the product's static charge while the product moves within the vacuum environment. Prior art measurement methods are done atmospherically, and the product must be removed from the vacuum environment before measurement.

Further, prior art practice places ionizers near the ceiling of the atmospheric handler that interfaces to the front of the process or metrology equipment. This placement is useful from the standpoint of achieving low charges at multiple locations within the atmospheric handler. But it is geographically unfocused. It misses the opportunity to provide focused (very fast) discharge times at the product pass-through door, which separates the atmospheric handler from the vacuum equipment.

Static charge control for vacuum processes could be improved by (a) adding more atmospheric ionizing capability close to the product pass-through door, (b) adding a charge measurement module inside the vacuum environment, (c) adding a low-pressure charge neutralization chamber into the vacuum cluster, (d) providing a way to introduce gas ions into the vacuum cluster itself, and (e) providing a way to introduce gas ions into the load-lock which interfaces with the vacuum cluster.

A system approach is needed wherein the most productive improvements are combined as needed.

### BRIEF SUMMARY OF THE INVENTION

In the following text, four types of ionizers will be recited. They are (1) a manifold ionizer, (2) a neutralizing ionizer, (3) a cluster ionizer, and (4) a load-lock ionizer. All of these four ionizers are a type of in-line gas ionizer. An in-line gas ionizer is defined as an ionizer that receives compressed air or gas at its inlet, ionizes the inlet gas within an enclosed chamber, and delivers ionized gas from the outlet.

The present invention implements static charge measurements and static charge removal on products within the vacuum environment and within the atmospheric environment. This is accomplished by adding any one, any two, any three, any four, or all of the following five structures to vacuum process or metrology equipment.

The first structure is an atmospheric manifold, which transports air (or gas) ions from a manifold ionizer into an atmospheric environment. An atmospheric manifold is installed proximal to the product pass-through door and blows ions toward the center of the pass-through door. This atmospheric manifold may be on the atmospheric side of the pass-through door, the vacuum cluster side of the pass-through door, or in-between the atmospheric and cluster sides. Atmospheric manifolds may be configured as loops, but other shapes are acceptable.

The second structure is a charge measurement module, which attaches to the vacuum cluster with a hermetic seal. It measures the accumulated static charge on the product. This measurement module may utilize the principle of an electrostatic field meter. Electrostatic field measurement is desirable because no contact is required. As the robot moves the product past an electrostatic field meter, charge is quantified. Alternately, charge measurement can be based on a Faraday Cup. A Faraday Cup is desirable due to simplicity. Basically, a Faraday Cup is a first cup within a second cup wherein the two cups are electrically isolated. A Faraday Cup can also measure product charge without making contact. Other measurement principles are applicable, and remain within the scope of this invention.

Regardless of measurement principle, the wafer or product is moved by a vacuum robot from any vacuum station into the charge measurement module. The wafers remain in vacuum during charge measurement.

When the product to be measured is conductive or dissipative, the vacuum robot should have non-conductive pickup contact points. Otherwise, the charge could be grounded prior to measurement.

The third structure is a neutralizing module that attaches to the vacuum cluster with a hermetic seal. The neutralizing module receives gas ions from a neutralizing ionizer while a connected neutralizing pump (a vacuum pump) maintains low pressure. Inside the neutralizing module, a flow of ionized gas neutralizes charge on the wafer or product. An isolation valve between the neutralizing module and the vacuum cluster is closed during neutralization.

The fourth structure is a cluster ionizer that is inserted into the vacuum cluster vent line, and that is capable of ionizing argon. A cluster ionizer is used to introduce gas ions into the vacuum cluster during venting or during the process itself. In addition to static charge control, reduced preventative maintenance cycles are targeted.

The fifth structure is a load-lock ionizer that is connected to the load-lock and that is capable of ionizing argon. A load-lock ionizer is used to introduce gas ions into the load-lock during pump down or venting. The load-lock pump (vacuum pump) operates during pump down, and may also operate during a portion of the venting period. In addition to static charge control, reduced preventative maintenance cycles are targeted.

Objects of this inventions are:

(1) provide a system approach to control static charge for vacuum equipment, (2) enable rapid charge removal as a product leaves or enters the atmospheric handler through a pass-through door; (3) provide a module to measure charge on a product while that product remains inside the vacuum environment; (4) provide a way to remove charge that accumulates inside the vacuum cluster environment, (5) provide a way to remove charge that accumulates inside the load-lock, (6) reduce particle buildup inside the vacuum cluster, and (7) reduce particle buildup inside the load-lock.

### BRIEF SUMMARY OF THE FIGURES

FIG. 1 is a top-view planar diagram of a vacuum cluster with process or metrology modules attached. The vacuum cluster is interfaced with an atmospheric handler. A charge measurement module is positioned on one side on the vacuum cluster, and a charge measurement meter is connected to the charge measurement module. An atmospheric manifold is positioned inside the wafer handler.

FIG. 2 is a modification of FIG. 1. This figure shows a cluster pump used to pump the vacuum cluster down to vacuum at the beginning of each processing cycle. A cluster vent line is also shown. The cluster vent line is used to return the vacuum cluster to atmospheric pressure at the conclusion of the process cycle.

FIG. 3 shows a cluster ionizer disposed between a pressurized gas source and the vacuum cluster.

FIG. 4 is a top-view planar diagram of a vacuum cluster with process or metrology modules attached. The vacuum cluster receives wafers (or products) from an atmospheric handler. A charge measurement module is positioned on one side of the vacuum cluster, and a measurement meter is connected to the charge measurement module. An atmospheric manifold is positioned between the atmospheric handler and the load-lock.

FIG. 5 shows a vacuum cluster with a neutralizing module connected. The neutralizing module receives gas ions from a neutralizing ionizer. A neutralizing pump maintains a low pressure within the neutralizing module.

FIG. 6 shows a vacuum cluster with a combined charge measurement and neutralizing module. A measurement meter receives signals that contain charge information. Gas ions are delivered by a neutralizing ionizer. A neutralizing pump maintains a low pressure within the combined module.

FIG. 7 shows an atmospheric manifold disposed at the wafer (or product) pass-through door. The atmospheric manifold receives gas ions from a manifold ionizer. The atmospheric manifold can be positioned on either side of the pass-through door.

FIG. 8 shows a load-lock ionizer providing air, nitrogen or argon ions to a load-lock through a load-lock ion delivery line.

### DETAILED DESCRIPTION

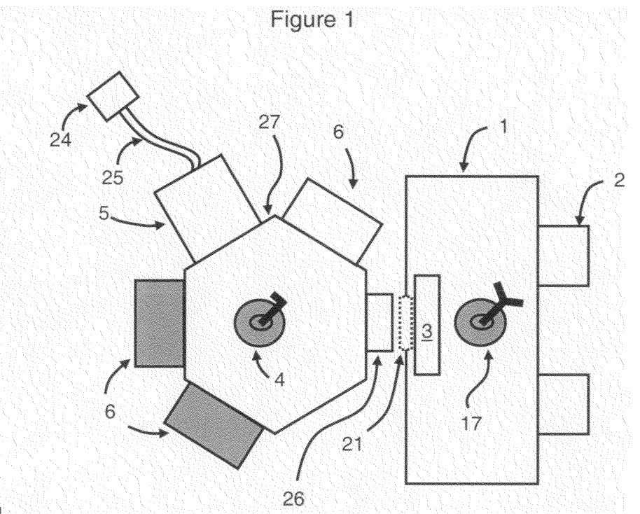

FIG. 1 shows the basic structural elements of vacuum cluster 27 architecture. Vacuum cluster 27 architecture is applicable when multiple vacuum processing steps are performed sequentially.

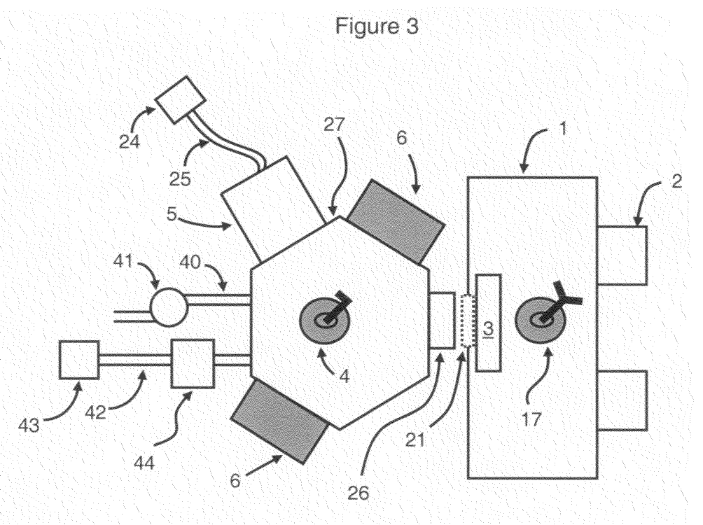

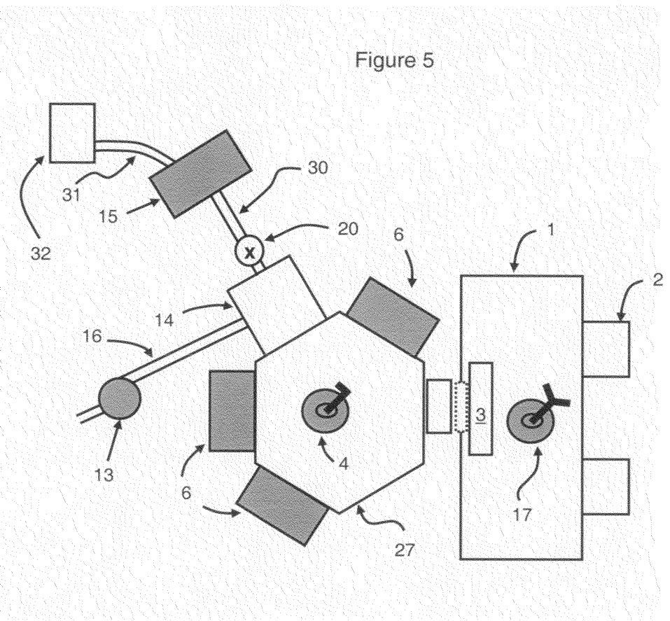

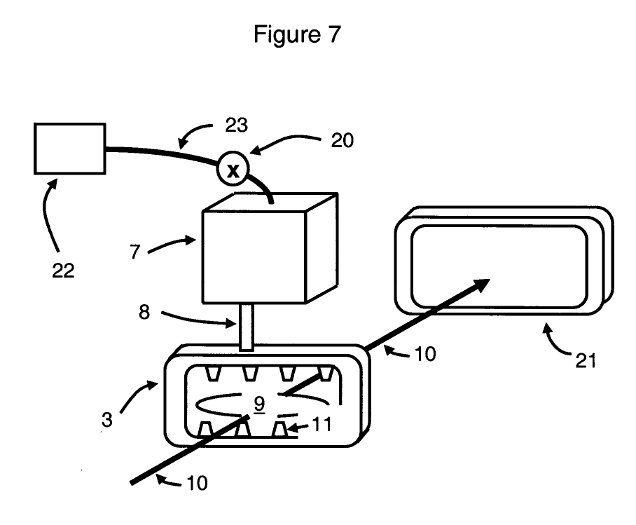

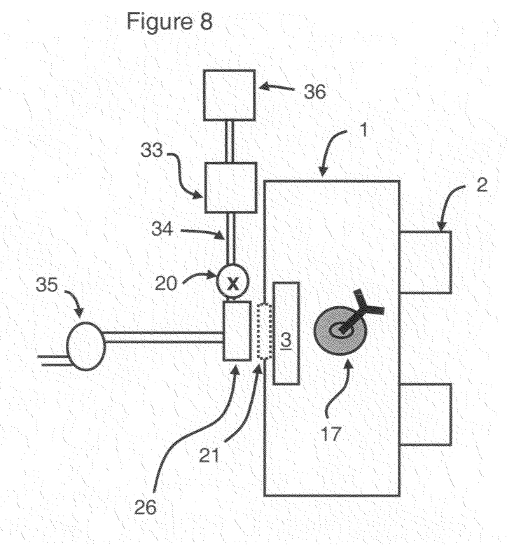

A systems approach to static charge control in a vacuum cluster 27, based on five inter-related structural elements, is the core of this invention. The five structural elements are:
(a) an atmospheric manifold 3 connected to a manifold ionizer 7 [see FIG. 7],
(b) a charge measurement module 5 connected to a measurement meter 24 [see FIG. 1],
(c) a neutralizing chamber 14 connected to a neutralizing ionizer 15 [see FIG. 5],
(d) a load-lock 26 connected to a load-lock ionizer 33 [see FIG. 8], and
(e) a vacuum cluster 27 connected to a cluster ionizer 44 [see FIG. 3].

Contributions from any one, any two, any three, any four, or all five structural elements are combined to provide a system which provides the static charge control necessary. Any of the five elements is included, depending on where and how static charge is generated.

Not all five structural elements are required for every static charge control system. For example, an operator who believes that incoming wafers are uncharged may elect to omit an atmospheric manifold near the pass-through door 21, and still remain within the scope of this invention. In contrast, an operator who receives a FOUP 2 [front opening universal pod] of wafers 9 (or product) from a spin-rinse-dryer will probably incorporate an atmospheric manifold 3 into his static charge control system.

In a similar way, if the charge measurement chamber 5 indicates that charge buildup inside the vacuum cluster 27 is sufficiently low to prevent product damage, the neutralizing module 14 may not be used. Charge removal by the atmospheric manifold 3 upon return to atmosphere may suffice.

In cases where a FOUP of charged wafers is received from a spin-rinse-dryer (or any prior charging step) and charges accumulate inside the vacuum cluster 27, all five structural elements are appropriately incorporated into the invented system.

Optional system control software interfaces with the five structural elements, and embeds decision making capability. Additional atmospheric sensors for balance, swing, or discharge time may also be integrated into system control software.

System control software is particularly useful when one vacuum cluster 27 is utilized for multiple product lines. Input from the charge measurement chamber 5 may automatically activate the neutralizing module 14 for product A and omit a neutralization step for product B. Where a single product is run and historical data show repeatable charging levels, preset values obviate the need for optional system control software.

Refer to FIG. 1. In a typical wafer processing scenario, the atmospheric handler 1 receives wafers 9 (or product) from a FOUP 2, and passes the wafers 9 through a pass-through door 21 into the load-lock 26 of the vacuum cluster 27. Process or metrology stations 6 are positioned and sealed onto the vacuum cluster 27 using prior art hermetic sealing technology. Each process or metrology station 6 is isolated from the vacuum cluster 27 during use with a prior art isolation valve.

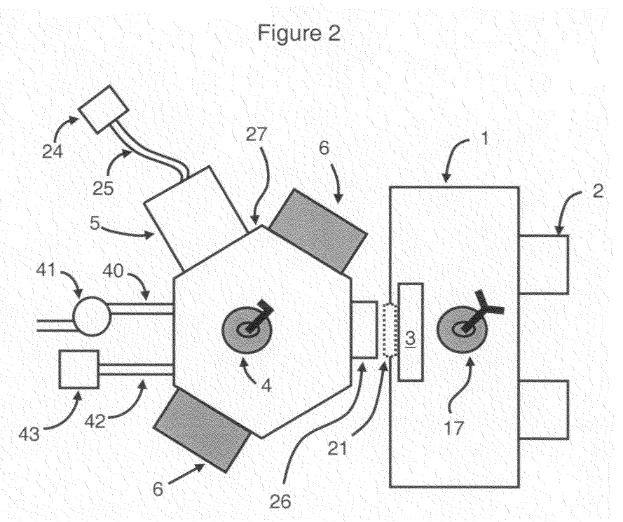

Refer to FIG. 2. The vacuum cluster 27 is pumped down through cluster evacuation line 40 by the cluster pump 41. Then all processing steps are performed by the process or metrology stations 6 as the vacuum robot 4 moves the wafers 9 (or product) among process or metrology stations 6. After processing, the wafers are transferred back into the load-lock 26, vented to atmospheric pressure, and returned to the atmospheric handler 1. The vacuum cluster 27 normally remains at vacuum because the pump down time for a vacuum cluster 27 can be long. However, the vacuum cluster 27 can be brought to atmospheric pressure with a cluster gas 43 through cluster vent line 42.

An atmospheric manifold 3 can be placed at any of three positions. Sometimes, two or more atmospheric manifolds 3 are used. FIG. 1, FIG. 2, and FIG. 3 show the atmospheric manifold 3 positioned on the atmospheric handler 1 side of the pass-through door 21. This is the first of the three positions.

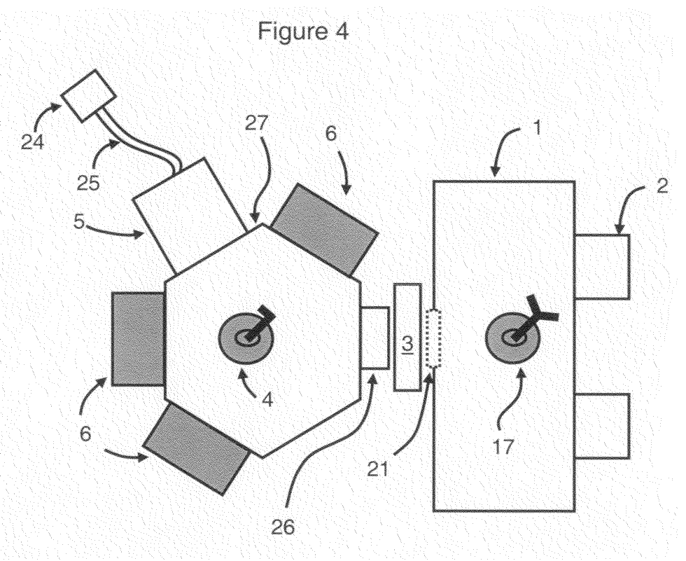

FIG. 4 shows the atmospheric manifold 3 positioned on the vacuum cluster 27 side of the pass-through door 21. This is the second of the three positions.

The atmospheric manifold 3 may also be positioned inside an extension zone which connects the pass-through door 21 to the load-lock 26. This is the third of the three positions.

Refer to FIG. 7. When a wafer 9 (or product) is transported through the pass-through door 21 along wafer path 10, the atmospheric manifold 3 blows ionized manifold gas through the manifold nozzles 11 toward the wafer 9 (or product). Because the atmospheric manifold 3 is close to the wafer 9 (or product), excess charge is quickly and effectively removed from the wafer 9.

FIG. 7 further shows that the atmospheric manifold 3 receives manifold gas ions from a manifold ionizer 7 through a manifold ion line 8. Compressed manifold gas 22 is transported to the manifold ionizer 7 through the manifold gas delivery line 23. The manifold ionizer 7 converts a fraction of the manifold gas 22 to manifold gas ions. Manifold gas ions impinge upon both the top and bottom of the wafer 9 as the atmospheric robot 17 moves the wafer 9 through the pass-through door 21.

For an atmospheric manifold 3 near the pass-through door 21, air or nitrogen are appropriate choices for manifold gas 22.

A loop-shaped atmospheric manifold 3 which conforms to the shape of the pass-through door 21 is an efficient design. For example, if the pass-through door 21 is rectangular, the atmospheric manifold is substantially rectangular and encircles the pass-through door 21. Manifold nozzles 11 on the inner perimeter of the loop-shaped atmospheric manifold 3 guide the manifold gas ions inward toward the center of the atmospheric manifold 3.

Atmospheric manifold 3 volumes are minimized in an effort to reduce air ion recombination. Also, the manifold ion line 8 between the manifold ionizer 7 and the atmospheric manifold 3 is minimized.

Open-ended (as opposed to-loop shaped) atmospheric manifolds may also be used to gain shorter discharge times via air entrainment. In this design, ions are transported from a manifold ionizer 7 through multiple tubes. For enhanced performance, an air entrainment port (open to atmosphere) may be positioned on each tube. The exit openings of the tubes are directed toward the center of the pass-through door 21 where the wafer 9 (or product) passes.

Refer to FIG. 8. Load-lock gas 36 is delivered to a load-lock ionizer 33 that converts a fraction of the load-lock gas 36 into load-lock gas ions. The load-lock ionizer 33 operates during transition periods between atmospheric pressure and vacuum. The load-lock ionizer 33 may be located within the load-lock 26. Alternately, the load-lock ionizer 33 may be located outside of the load-lock 26. When installed outside, and load-lock gas ions are delivered to the load-lock 26 through a load-lock ion delivery line 34. The load-lock pump 35 may or may not be operating when gas ions are being delivered.

Load-lock 26 ionization is useful for two reasons. First, static charges on wafers 9 or products are neutralized. Second, ionization helps clean the load-lock 26 walls during pump down and venting. Wall cleaning is advantageous because it mitigates an established contamination mechanism.

Consider the case, where wafers 9 from a high-particle-content vacuum process step are returned to the load-lock 26. Some of the particles are carried from the process by the wafer 9 into the load-lock 26. The venting step dislodges particles from the wafer 9, and the dislodged particles are deposited onto the load-lock 26 walls. Here, they are poised to contaminate the next lot of incoming wafers 9 during pump-down. Over time, particles within the load-lock 26 accumulate to problematic levels. The prior art solution is to frequently withdraw the equipment from service and do a preventative maintenance cleaning.

Installing a load-lock ionizer 33 into the load-lock 26 neutralizes particles which accumulate on the load-lock 26 walls. This is advantageous because neutral particles are easier to remove from a surface than charge particles. A short-duration rough pumping (turbulent) step after activating the load-lock ionizer 33 minimizes particle accumulation and reduces the frequency of preventative maintenance cleaning. Wafers may or may not be inside the load-lock 26 during the short-duration rough pumping, which is accomplished with a load-lock pump 35.

When a load-lock ionizer 33 is connected to a load-lock 26, at least one shut-off valve 20 is recommended. The purpose is to prevent leakage of the compressed load-lock gas into the vacuum environment when the load-lock ionizer 33 is not in use or when high vacuum is sought.

As wafers 9 move toward processing, they leave the load-lock 26 and enter the vacuum cluster 27. Then, the vacuum cluster 27 is pumped down to vacuum, and a vacuum robot 4 moves the wafer 9 among process or metrology stations 6. The process or metrology stations 6 perform a variety of process steps or measurements.

Refer to FIG. 2. After any process step, the accumulated static charge on the wafer 9 can be measured by moving the wafer 9 to the charge measurement module 5. Signals from the charge measurement module 5 are transmitted to the measurement meter 24 through signal lines 25. No return to atmospheric condition is needed for the static charge measurement.

The charge measurement module 5 typically employs the principle of a Faraday Cup or an electrostatic field meter. Both Faraday Cups and electrostatic field measurement principles are within the prior art. But neither Faraday Cups nor electrostatic field sensors have been configured as modules that are hermetically sealed to a vacuum cluster 27. Other measurement principles are within the scope of this disclosure providing that the charge measurement can be performed in a vacuum environment.

FIG. 5 shows a neutralizing module 14. The neutralizing module 14 receives neutralizing gas ions from a neutralizing ionizer 15 through a neutralizing ion delivery line 30. Pressurized neutralizing gas 32 is supplied to the neutralizing ionizer 15 via a neutralizing gas line 31, and neutralizing gas ions are produced by the neutralizing ionizer 15. A charged wafer 9 (or product) is placed into the neutralizing module 14 with the vacuum robot 4, and an isolation valve is closed. The stream of neutralizing gas ions from the neutralizing ionizer 15 impinge upon the wafer 9, and are evacuated by the neutralizer pump 13. A shut-off valve 20 is recommended to avoid neutralizing gas 32 leakage when the neutralizing module 14 is not in use.

Typically, the internal volume of the neutralizing module 14 is small, the flow of neutralizing gas is minimal, and pressure within the neutralizing module 14 remains low. These conditions are useful to re-establish vacuum quickly after the neutralization operation. The neutralizing module 14 must be returned to vacuum before the valve between the neutralizing module 14 and the vacuum cluster 27 is re-opened.

Low pressure inside the neutralizing module 14 is obtained by exposing the neutralizing module 14 to a throttled neutralizing pump line 16 while the flow of neutralizing gas ions proceeds. The neutralizing pump line 16 is evacuated by the neutralizer pump 13.

An neutralizing ionizer 15 that can ionize argon gas is employed in those processes where argon gas is used for venting. Experiments have shown that commercially available in-line gas ionizers can ionize argon. Performance of the neutralizing ionizer 15 for argon can be augmented by operating at higher voltages. Argon is a common venting choice.

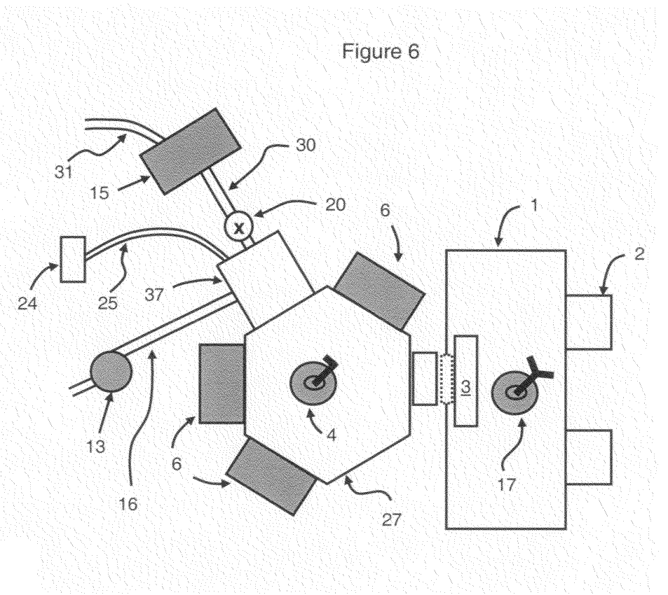

In FIG. 6, the charge measurement module 5 and the neutralizing module 14 are integrated into a combined module 37 that (a) measures static charge and (b) removes static charge. This approach only uses one position on the vacuum cluster 27, and saves time by allowing two operations at one location. It also permits real-time interaction between the charge measurement module and charge neutralization.

Note that the wafer 9 or product is not returned to atmospheric pressure for either charge measurement or charge neutralization.

The instant invention also allows the entire vacuum cluster 27 to be neutralized with cluster gas ions from the cluster ionizer 44 through cluster vent line 42. Cluster gas 43 (often argon) is plumbed to the inlet of the cluster ionizer 44.

Although the vacuum cluster 27 is normally maintained at vacuum, a periodic flush with ionized cluster gas is useful for cleaning. Again, the goal is less frequent preventative maintenance cleanings.

The cluster ionizer 44 also has process applications. Since argon is also used for sputtering, ionizing the sputtering gas is practical.

We claim:

1. An apparatus for measuring static charge within vacuum equipment comprising:
a vacuum robot;
a plurality of vacuum process stations served by said vacuum robot;
a vacuum cluster that interfaces to each said process station; and
a charge measurement module attached to said vacuum cluster with a hermetic seal.

2. Claim 1 where said vacuum robot delivers said wafer or product to said charge measurement module.

3. Claim 1 where said charge measurement module comprises a Faraday Cup.

4. Claim 1 where said charge measurement module quantifies electrostatic fields.

5. Claim 1 where a charge measurement meter is disposed outside of the vacuum environment.

6. Claim 2 where delivery to said charge measurement module does not include a venting step.

7. An apparatus for neutralizing static charge on a wafer or product within vacuum equipment comprising:
a vacuum robot;
a plurality of vacuum process or metrology stations served by said vacuum robot;
a vacuum cluster that interfaces to each said process or metrology station;
a neutralizing module attached to said vacuum cluster with a hermetic seal; and
a neutralizing ionizer which receives non-ionized neutralizing gas and delivers neutralizing gas ions into said neutralizing module.

8. Claim 7 where said vacuum robot delivers said wafer or product to said neutralizing module.

9. Claim 7 where said neutralizing module receives neutralizing gas ions from a neutralizing ionizer.

10. Claim 7 where said neutralizing gas ions comprise any one selected from ionized air, ionized nitrogen, and ionized argon.

11. Claim 7 where said neutralizing ionizer produces neutralizing gas ions from a pressurized gas source.

12. Claim 7 where said neutralizing module is further connected to a neutralizer pump.

13. Claim 7 where said neutralizing module further functions as a charge measurement module.

14. An apparatus for neutralizing static charge on a wafer or product at the pass-through door wherein said pass-through door is disposed between an atmospheric handler and a vacuum load-lock comprising:
an atmospheric manifold disposed at the perimeter of said pass-through door;
a manifold ionizer that creates manifold gas ions and delivers said manifold gas ions into said atmospheric manifold; and
manifold nozzles disposed within said atmospheric manifold that direct said manifold gas ions toward said wafer or product when said wafer or product passes through said pass-through door.

15. Claim 14 where said manifold gas ions comprise any one selected from ionized air, ionized nitrogen, or ionized argon.

16. Claim 14 where said atmospheric manifold is positioned on the side of said pass-through door which faces toward said atmospheric handler.

17. Claim 14 where said atmospheric manifold is positioned on the side of said pass-through door which faces said load-lock.

18. An apparatus for neutralizing static charge inside a load-lock leading to a vacuum cluster comprising:
a pressurized source of load-lock gas;
a load-lock ionizer which receives said load-lock gas from said pressurized source and converts a fraction of said load-lock gas into load-lock gas ions;
a load-lock ion delivery line disposed between said load-lock ionizer and said load-lock.

19. Claim 18 where said load-lock gas is any one selected from air, nitrogen, and argon.

20. Claim 18 further comprising a load-lock pump.

21. Claim 18 where said load-lock ionizer is physically disposed within said load-lock.

22. Claim 18 where said load-lock ion delivery line comprises the outlet port of said load-lock ionizer.

23. An apparatus for neutralizing static charge inside a vacuum cluster comprising:
a pressurized source of cluster gas;
a cluster ionizer which receives said cluster gas from said pressurized source and converts a fraction of said cluster gas into cluster gas ions;
a cluster ion delivery line between said cluster ionizer and said vacuum cluster.

24. Claim 23 where said cluster gas is any one selected from air, nitrogen, and argon.

25. Claim 23 further comprising a cluster pump.

26. Claim 23 where said cluster ionizer is physically disposed outside of said vacuum cluster.

27. Claim 23 where said cluster ion delivery line comprises the outlet port of said cluster ionizer.

28. A system for measuring or controlling static charge inside process or metrology equipment that utilizes a vacuum cluster comprising:
a vacuum robot;
a plurality of vacuum process stations served by said vacuum robot;
a vacuum cluster that interfaces to each said process station;
a charge measurement module attached to said vacuum cluster; and
an in-line gas ionizer which creates gas ions and delivers said gas ions to one of
the perimeter of a pass-through door,
a load-lock,
said vacuum cluster, and
a neutralizing module.

29. Claim 28 where control software allows said charge measurement module or said in-line gas ionizer to be fully active, partially active, or inactive.

30. Claim 29 where said control software receives input data from said charge measurement module and uses said input data to adjust said in-line gas ionizer.

31. Claim 29 where said control software further receives input data from atmospheric sensors that measure ion balance, sensors that measure discharge time, or sensors that measure swing.

32. A system for measuring or controlling static charge inside process or metrology equipment that utilizes a vacuum cluster comprising:
a vacuum robot;
a plurality of vacuum process stations served by said vacuum robot;
a vacuum cluster that interfaces to each said process station;
a charge measurement module attached to said vacuum cluster; and
any one selected from
a manifold ionizer,
a load-lock ionizer,
a cluster ionizer, and
a neutralizing ionizer.

33. A system for measuring or controlling static charge inside process or metrology equipment that utilizes a vacuum cluster comprising:
a vacuum robot;
a plurality of vacuum process stations served by said vacuum robot;
a vacuum cluster that interfaces to each said process station;
a charge measurement module attached to said vacuum cluster; and
any two selected from
a manifold ionizer,
a load-lock ionizer,
a cluster ionizer, and
a neutralizing ionizer.

34. A system for measuring or controlling static charge inside process or metrology equipment that utilizes a vacuum cluster comprising:
a vacuum robot;
a plurality of vacuum process stations served by said vacuum robot;
a vacuum cluster that interfaces to each said process station;
any one chosen from a charge measurement module and a neutralizing module; and
any one selected from
a manifold ionizer,
a load-lock ionizer,
a cluster ionizer, and
a neutralizing ionizer.

35. A method of using in-line gas ionizers to control static charge inside process or metrology equipment that utilizes a vacuum cluster comprising:
providing one or more sources of pressurized gas;
connecting each said source of pressurized gas to the inlet of an in-line gas ionizer;
creating gas ions with said in-line gas ionizer;
delivering said gas ions to at least one selected from
an atmospheric manifold located at a pass-through door between an atmospheric handler and a load-lock,
said vacuum cluster,
said load-lock, and
a neutralizing chamber that is attached to said vacuum cluster.

36. Claim 35 further comprising a charge measurement module that is attached to said vacuum cluster.

37. Claim 35 where said pressurized gas is any one selected from air, nitrogen, and argon.

38. A method of reducing particle buildup inside a vacuum cluster comprising:
inserting a cluster ionizer into the vent line of said vacuum cluster;
supplying a source of cluster gas to the inlet of said cluster ionizer;
ionizing a portion of said cluster gas with said cluster ionizer to create cluster gas ions; and
delivering said cluster gas ions into said vacuum cluster.

39. Claim 38 where said cluster gas comprises any one of air, nitrogen and argon.

40. A method of reducing particle buildup inside a load-lock comprising:
inserting a load-lock ionizer into the vent line of said load-lock;
supplying a source of load-lock gas to the inlet of said load-lock ionizer;
ionizing a portion of said load-lock gas with said load-lock ionizer to create load-lock gas ions; and
delivering said load-lock gas ions into said load-lock.

41. Claim 40 where said load-lock gas comprises any one of air, nitrogen and argon.

42. A method of ionizing sputtering gas that is delivered to a vacuum cluster comprising:
inserting a cluster ionizer into the vent line of said vacuum cluster;
supplying a source of cluster gas to the inlet of said cluster ionizer;
ionizing a portion of said cluster gas with said cluster ionizer to create cluster gas ions; and
delivering said cluster gas ions into said vacuum cluster.

43. Claim 42 where said cluster gas comprises any one of air, nitrogen and argon.

44. A method of neutralizing wafers which are processed in a vacuum cluster comprising:
measuring the charge on said wafers within an atmospheric handler;
moving said wafers from said atmospheric handler to said vacuum cluster;
processing said wafers at process stations within said vacuum cluster;
measuring said wafers' charge after any processing step;
comparing said wafers' charge to a charge limit;
neutralizing and re-measuring said wafers repeatedly until said wafers' charge is within said charge limit; and
returning said wafer to said atmospheric handler.
